(19) United States
(12) Patent Application Publication
(10) Pub. No.: US 2006/0277594 A1
(43) Pub. Date: Dec. 7, 2006

(54) Policy implementation delegation

(75) Inventors: Arlindo Chiavegatto JR., Cary, NC (US); Anuradha Bhamidipaty, New Delhi (IN); Manish A. Bhide, New Delhi (IN); Rajeev Gupta, New Delhi (IN); Mukesh K. Mohania, New Delhi (IN); Shourya Roy, New Delhi (IN)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/143,033

(22) Filed: Jun. 2, 2005

(51) Int. Cl. H04L 9/00; H04L 9/32; H04N 7/16; G06F 17/00; G06K 9/00; H04K 1/00; G06F 17/30; G06F 7/04; H03M 1/68

(52) U.S. Cl. 726/2; 726/1; 713/165; 713/166; 713/167; 726/26; 726/27

(57) ABSTRACT

The present invention allows a user (e.g., a policy implementer) to be identified and delegated responsibility for implementing a policy. This can occur, implicitly, semi-implicitly or explicitly. In a typical embodiment, a policy provided (e.g., by a policy owner) is automatically parsed to determine a minimum set of access rights needed to implement the policy. For example, the policy might indicate that an implementing user only needs simple read privileges. Alternatively, the policy might require read/write privileges. In any event, a list (e.g., an access control list) will be analyzed to identify a set (e.g., one or more) of users of a computerized resource subject to the policy that meets the minimum set of access rights. Once this set of users has been identified, a hierarchy can be optionally analyzed to determine who among the set of users is permitted to implement the policy.

### BACKGROUND OF THE INVENTION

1. Field of the Invention

The present invention generally relates to policy implementation delegation. Specifically the present invention provides a way to automatically determine the individual(s) within an organization to whom implementation of a computer-based policy can be delegated.

2. Related Art

As computer infrastructures are becoming more sophisticated, “policies” are playing an ever expanding role in their management. In general, a policy dictates how a certain resource within a computer infrastructure can be utilized and/or accessed. Policies in a typical organization are acted upon by three different kinds of entities: (1) the policy owner/author who is generally a senior level business manager in charge of defining the policies for the organization; (2) the domain expert who is responsible for encoding the policy in a proper syntactic format; and (3) the policy implementer whose privileges will be used to implement the policy.

As an example, consider the following policy: “All databases having personally identifiable information or confidential information should be encrypted.” Such a policy is generally set by high level information technology (IT) administrators. Thus, the owner of this policy might be the senior IT administrator. A department level administrator would convert this into syntactic format and would possibly create a template such as “All HR databases having employee personal information, all employee appraisal data, and all project reports databases should be encrypted.” The issue here is that neither the policy owner nor the domain expert might have access to the systems on which the policy is to be enforced. Hence, the implementation and/or enforcement of such policies will be done by the Finance Manager (for employee personal information), the Department Manager for employee appraisal data, and the project team member for the project reports database or employees that have being delegated by one of them. Finding the right person for implementing the policy for the right database can be a difficult task given the large number of databases/managed systems in a typical organization. It might also be the case that the action in a policy is composed of several sub-actions each requiring different set of access rights. Adding to this complexity is the fact that the right person to implement a policy might change dynamically due to various factors, such as a person leaving a job, change in project responsibilities, delegation, etc. Even if the domain expert (e.g., department manager) determines the right person for each policy, the domain expert has to ensure that each of the policies is correctly enforced.

Heretofore, the delegation of policy implementation (i.e., delegation from a policy owner to a policy implementer) has been a manual process. That is, a policy owner will manually identify one or more individual(s) within the organization who are “qualified” to implement the policy, and then the policy owner will manually delegate the implementation to that individual(s). Given the large number of individuals that can exist within an organization, identifying one or more for delegation of the policy can be an extremely laborious process. That is, such identification might require an analysis of access rights and the like to determine who has sufficient authority to implement the policy for the associated resource.

In view of the foregoing, there exists a need for a technology which will automatically identify a user of a computerized resource to whom implementation of a corresponding policy can be delegated.

### SUMMARY OF THE INVENTION

In general, the present invention provides a method, system and program product for delegating policy implementation. Specifically, the present invention allows a user (e.g., a policy implementer) to be identified and delegated responsibility for implementing a policy. This can occur, implicitly, semi-implicitly or explicitly. In a typical embodiment, a policy provided (e.g., by a policy owner) is automatically parsed to determine a minimum set of access rights needed to implement the policy. For example, the policy might indicate that an implementing user only needs simple read privileges. Alternatively, the policy might require read/write privileges. In any event, a list (e.g., an access control list) will be analyzed to identify a set (e.g., one or more) of users of a computerized resource subject to the policy that meets the minimum set of access rights. In one embodiment, the set of users can be identified based upon their respective roles within the organization. Regardless, once this set of users has been identified, a hierarchy can be optionally analyzed to determine who among the set of users is permitted to implement the policy. This optional step is typically based on a hierarchical relationship of the set of users to the owner of the policy. Accordingly, the hierarchy should at least contain hierarchical relationships of the individuals/users within the organization containing the computerized resource.

A first aspect provides a computer-implemented method for delegating policy implementation, comprising: parsing a policy to determine a minimum set of access rights needed to implement the policy; analyzing a list to identify a set of users of a computerized resource subject to the policy that meets the minimum set of access rights; and identifying at least one user from the set of users to implement the policy for the computerized resource.

A second aspect provides a system for delegating policy implementation, comprising: a system for parsing a policy to determine a minimum set of access rights needed to implement the policy; a system for analyzing a list to identify a set of users of a computerized resource subject to the policy that meets the minimum set of access rights; and a system for identifying at least one user from the set of users to implement the policy for the computerized resource.

A third aspect provides a program product stored on a computer readable medium for delegating policy implementation, the computer readable medium including program code, which when executed on a computer causes the computer to: parse a policy to determine a minimum set of access rights needed to implement the policy; analyze a list to identify a set of users of a computerized resource subject to the policy that meets the minimum set of access rights; and identify at least one user from the set of users to implement the policy for the computerized resource.

A fourth aspect provides a method for deploying an application for delegating policy implementation: providing a computer infrastructure being operable to: parse a policy to determine a minimum set of access rights needed to implement the policy; analyze a list to identify a set of users of a computerized resource subject to the policy that meets the minimum set of access rights; and identify at least one user from the set of users to implement the policy for the computerized resource.

A fifth aspect provides computer software embodied in a propagated signal for delegating policy implementation, the computer software comprising instructions for cause a computer system to perform the following functions: parse a policy to determine a minimum set of access rights needed to implement the policy; analyze a list to identify a set of users of a computerized resource subject to the policy that meets the minimum set of access rights; and identify at least one user from the set of users to implement the policy for the computerized resource.

Therefore, the present invention provides a method, system and program product for delegating policy implementation.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for delegating policy implementation according to the present invention.

FIG. 2 shows the resource manager of FIG. 1 in greater detail.

FIG. 3 shows a more specific computerized implementation according to the present invention.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes, the Detailed Description of the Invention will have the following sections:

I. Introduction

II. Delegation Approaches

III. Resource Manager

IV. Computer System Implementation

I. Introduction

In general, the present invention provides a method, system and program product for delegating policy implementation. Specifically, the present invention allows a user (e.g., a policy implementer) to be identified and delegated responsibility for implementing a policy. This can occur, implicitly, semi-implicitly or explicitly. In a typical embodiment, a policy provided (e.g., by a policy owner) is automatically parsed to determine a minimum set of access rights needed to implement the policy. For example, the policy might indicate that an implementing user only needs simple read privileges. Alternatively, the policy might require read/write privileges. In any event, a list (e.g., an access control list) will be analyzed to identify a set (e.g., one or more) of users of a computerized resource subject to the policy that meets the minimum set of access rights. In one embodiment, the set of users can be identified based upon their respective roles within the organization. Regardless, once this set of users has been identified, a hierarchy can be optionally analyzed to determine who among the set of users is permitted to implement the policy. This optional step is typically based on a hierarchical relationship of the set of users to the owner of the policy. Accordingly, the hierarchy should at least contain hierarchical relationships of the individuals/users within the organization containing the computerized resource.

It should be understood in advance that as used herein the term “set” is intended to mean one or more. In addition, the term “user” is intended to refer to an individual who can access or otherwise interact with a computerized resource of an organization. Still yet, the term “implementation” as used with reference to a policy is intended to encompass, among other things, the execution and/or enforcement of a policy.

In a policy based system, policies are typically designed by the top decision-making managers in a high-level language (e.g., in a natural language script or at business object level) without being concerned about the implementation level details. These business policies are then converted into low-level policies by the domain expert who has the knowledge about the resource specific low-level entities, business objects, and the mapping between the two. Once these high-level policies are mapped to the low-level policies, they are enforced by the system administrators or by (low-profile) managers who have more hands on experience and in-depth knowledge of the system. Thus, three sets of people are often involved: (1) policy owners (e.g., decision-making managers); (2) domain experts; and (3) policy implementers (e.g., system administrators and/or low-profile managers). These three types of people can have different roles/responsibilities. For example, the policy owner or domain expert may or may not have access to the resource being managed, while and the policy implementers might not be permitted to define policies since they are not aware about the overall business processes. Moreover, there could be multiple people who have access to the managed resources referred to in a policy and consequently the policy can be executed by any one of these people. Therefore, in such scenarios, it is important to authorize the delegation of policy implementation to the right person/user that has the required access to the managed entities. The delegation can be explicit as a “part of” policy, it can be implicit as a “matter of” policy, or it could be semi-implicit. The present invention provides a framework to handle these three cases

II. Delegation Approaches

As indicated above, the present invention provides a framework to accommodate multiple types of delegation: (1) explicit; (2) implicit; and (3) semi-implicit. In explicit delegation, the policy owner/domain expert knows the identity of the user with whose credentials the policy is to be enforced/implemented. Hence in this case, the policy owner/domain expert explicitly associates the policy implementer's identity with the policy which indicates the assigned identity that should be used to execute the defined policy on behalf of the policy owner/domain expert. For example, the policies related to the management of the mail server are decided by employee X, who can delegate the enforcement of them to any employee Y reporting to him/her. In this case, the policy owner knows (e.g., is made aware of) who has the right access to implement the policy.

In the case of implicit delegation, the policy owner/domain expert does not indicate who will implement/execute the policy. This may happen because of many reasons (e.g., the owner/domain expert of policy may not be aware of possible implementers of the policy, there may be more than one possible implementers of the policy, access rights of users may change from the time of creation of policy, etc.). Therefore, the present invention provides an intelligent autonomic system (e.g., agent) that can derive who will be the best implementer for a given policy, and then the identity of the policy implementer can be augmented with the policy so that it can be executed correctly. The system will also be responsible for keeping the policy up to-date with respect to the changes in the access rights of the users or other changes in the managed resource (referred in the policy) which might affect the execution of the policy.

The intelligent delegation system (IDS) of the present invention can also play a role in explicit delegation. For example, the IDS keeps track of the changes in the access rights of the user with whose credentials the policy is to be enforced. It also keeps track of the changes in the managed resource and ensures that in the event of changes to any of these the policy owner/domain expert is notified so that the policy remains active and correct at all times.

The third delegation approach is a middle-ground between the first two approaches mentioned above, which is termed above as semi-implicit identity delegation. In the semi-implicit approach, the IDS identifies the set of people who have access rights to execute the policy correctly, and makes this information available to the policy owner/writer who uses it to augment the policy. Thus, in this approach, the IDS plays a greater role that it does in the explicit delegation case.

III. Resource Manager

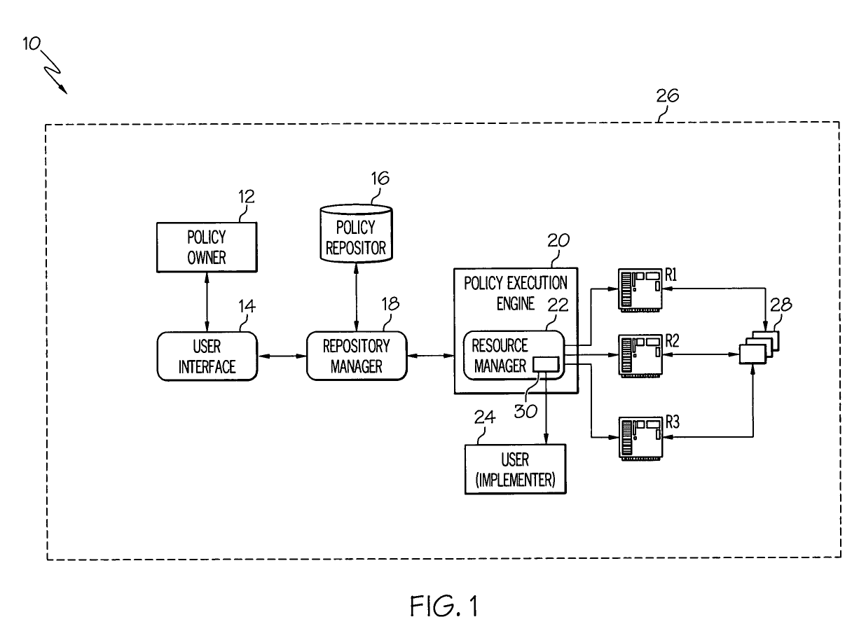

Referring to FIG. 1, a policy framework/system 10 for policy implementation delegation according to the present invention is shown. Before system 10 is described in grater detail, policy creation in general will be described. In a typical embodiment, policies are defined (e.g., by policy owner/author 12 using user interface 14) in a pre-decided format. An example format could include the following artifacts: (1) policy owner 12 (e.g., the person writing the policy); (2) resource (e.g., the computerized resource R1-R3 for which the policy is written); (3) precondition (e.g., the preconditions to run a policy); (4) policy-action (e.g., the actions to be taken on the particular resource R1-R3); and (5) execution time (e.g., the time of execution of the policy for temporal policies).

In system 10, policies can be written by an owner 12 that is also a “domain expert” using a user-interface 14. A repository-manager 18 provides an interface to store the policies in a persistent storage such as policy repository 16. Common examples of policy repository 16 could be a file system, a database, a Lightweight Directory Access Protocol (LDAP)/X.500 directory etc. The actual implementation of the policy, which includes checking when the policy should be executed, whether the pre-conditions defined in the policy are true, executing the action specified in the policy, etc., is furthered by a policy execution/implementation engine 20. R1, R2 and R3 are intended to represent computerized resources that are managed by the policy based system. The term “resource” is used in a generic sense to represent an entity that can be acted upon by policies. Examples of resources R1-R3 include an Internet Protocol (IP) address, a Database (DB2) instance, a router, etc. In any event, the components of system 10 shown in FIG. 1 typically exist within an IT environment of an organization 26 (e.g., a business, a company, etc.). It should be understood, however, that this need not be the case. For example, policy execution engine 20 could be provided by a third party that is independent of organization 26. Such a third party could be a service provider that offers policy implementation delegation services for customers.

Regardless, in order to support the concept of identity delegation, the present invention also provides a resource manager 22. Specifically, while policy execution engine 20 utilizes user credentials to perform various tasks on the managed resources R1-R3, the actual management of these credentials is a task that is done by resource manager 22. A typical example of a user credential is a user-ID and password. In such a case, the resource manager 22 maintains a table of the user-IDs and passwords of all possible users 28 of the managed resources, which are required for executing a policy. This table can be created as part of setting up the resource manager 22 and it can be stored in any boot-up configuration file. In WebSphere Application Server (“WAS,” which is commercially available from International Business Machines Corp of Armonk, N.Y.), such a table can be thought of as all the user-ID and passwords it collects for fixed identity configuration. This can also be implemented as a data source or a system variable in WAS. A password challenge will be popped-up for each user 28 whose user-ID is to be used for a resource if the corresponding password is missing from the table.

To support the concept of identity delegation under the present invention, an additional artifact (e.g., the policy implementer credential or policy implementer ID) is introduced in the policy grammar. In the case where the user credential is the user-ID and password, the policy implementer ID could be the user name of the policy implementer. As explained earlier, the differences between the three approaches of identity delegation stem from the way the policy implementer ID is derived. In explicit delegation case, the policy implementer ID is appended to the policy by the policy owner/Domain Expert 12. Based on their execution time and/or precondition, policies are executed by resource manager 22 on the specified resource R1-R3. The ID of the policy implementer is used by resource manager 22 to implement the policy. An example implementation of explicit delegation is the RunAs-identity mechanism available in various J2EE application servers. These servers give option of configuring the RunAs identity as system identity, a fixed identity or user identity.

In the case of implicit delegation, policy owner 12 does not explicitly specify the ID of the policy executor. The repository manager 18 will store the policy in policy repository 16 without any policy implementer ID. An identity delegation system (IDS 30) (e.g., an agent) is provided within resource manager 22 to populate the policy implementer ID into the policy, which is used to execute the policy at the run time.

As an example implementation, a design of IDS 30 for a data management domain, particularly, for managing the data in a Relation Database Management System (RDBMS) is proposed. In this case, IDS 30 determines: (1) what are the data tables and operations (e.g.,. actions) involved in the policy; (2) who all have access to perform these operations on data tables; and optionally (3) those policy implementers who have a certain hierarchical relationship to the policy owner in the organizational hierarchy with respect to the managed resources R1-R3.

As explained above IDS 30 determines the identity of the user to whom policy owner 12 can delegate its identity and who has “just” sufficient access rights to implement the policy. Thus, the inputs to IDS 30 include the policy identifier (e.g., the unique identity of the policy), the access rights required to implement the policy, the policy owner 12, the organization hierarchy (optional), the resource R1-R3 being managed, and the access privileges of various policy implementers. The output of IDS 30 includes the identity of the user(s) (also referred to as the policy executer/implementer) that can be used for the implementation of the policy. If there are more than one possible policy implementers, IDS 30 can be configured to choose the one who has the minimum access privilege on the resource R1-R3 being managed. If more than one policy implementers have the same minimum access rights, then the implementer can be chosen arbitrarily.

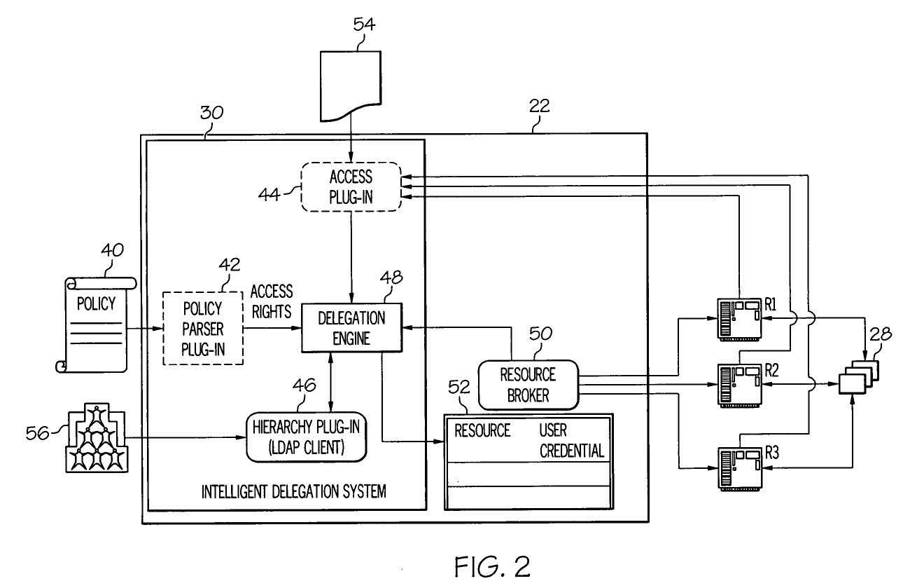

Referring now to FIG. 2, a more detailed diagram of resource manager 22 and IDS 30 is shown. As depicted, IDS 30 includes various components. These components include (1) a policy parser plug-in 42; (2) an access plug 44; (3) an optional hierarchy plug-in 46; and (4) a delegation engine 48. IDS 30 uses these components to help ensure that the system can be applied in different domains. It should be understood that some of the components are shown as plug-ins for exemplary and best mode purposes only. To this extent, they can be realized using other technology within the scope of the present invention. In any event, as further shown, delegation engine 48 also interacts with resource broker 50 and table 52. The purpose and function of each of the components shown in FIG. 2 will be further described below:

Policy parser plug-in 42: IDS 30 uses a resource specific policy parser plug-in 42 that parses the policy 40 (e.g., the policy precondition and policy-action) to get/determine a minimum set of access rights needed to implement policy 40. For example, consider a policy to manage a “sales” database (e.g., R1) with tables entitled “customer_bio” and “customer_sale” appearing in the action and precondition parts of policy 40, respectively. Further assume that in order to implement policy 40, “read” access is required for the table “customer_sale” and “update” access is required for the table “customer_bio”. Policy parser plug-in 42 will parse policy 40 and return this information to the delegation engine 48.

Access plug-in 44: Once policy parser plug-in 42 determines the minimum access rights needed to implement policy 40, a list of users who have sufficient access rights to the resource being managed to implement the policy will be identified by access plug-in 44. Specifically, access rights are typically stored within/as access control lists (e.g., list(s) 54) for the resource being managed. For different managed resources different mechanisms may be required to get the ACL(s) 54. For example, such information is stored in system tables for databases. Regardless, once delegation engine 48 receives the minimum access rights needed, access plug-in 44 will analyze list(s) 54 to identify a set of users who have sufficient access rights. This operation could involve determining information such as: (1) which user is allowed to write in table T1; (2) does user U1 belongs to “Administrators” group, etc. The latter approach would be identifying the set of users based upon their roles (and the access rights associated with those roles) within the organization.

For a DB2 database, a table entitled “systabauth” is typically used to store access rights of various users and groups. Through this table, a DB2 specific access plug-in 44 can obtain answers to questions such as: “is user U1 allowed to insert rows into the employee table?” The following SQL statements will provide the answer:
SELECT*FROM sysibm.systabauth WHERE grantee=‘U1’ AND TTName=“Employee” AND insertauth=‘y’.
If there are roles defined in the managed resource R1, the access rights returned by the policy parser plug-in 42 can be mapped to the roles and users belonging to the required role can be returned. In any event, as indicated above, specific plug-ins can be provided for specific resources or specific types of resources. As such, IDS 30 could contain N access plug-ins 44.

Hierarchy Plug-in 46 (Optional): The hierarchy plug-in 46 can optionally be used to determine who among the set of users identified by access plug-in 44 is permitted to implement the policy. This is typically accomplished based on a hierarchical relationship of the set of users to the owner of the policy. In general, there are multiple theories as to whom the owner can delegate the policy implementation. Under the first theory, an owner can delegate implementation of policies to employees who report to him/her directly or indirectly in organizational hierarchy 56. The organizational hierarchy 56 can be specific for a particular resource (e.g., if the owner manages two departments then hierarchy plug-in 46 will obtain the user-IDs of the employees reporting to the policy owner and belonging to the department (or resource) represented by the policy resource). Hierarchy plug-in 46, in this case, will determine who among the set of users report to the policy owner. The organizational hierarchy 56 is usually stored in LDAP directories or the like. An LDAP client is used to extract information from LDAP directories in intranet/internet. In determining who reports to the policy owner, an LDAP filter can be used by the client, and can resemble the following: “(& (manager=policy owner) (department=resource))”. Under the second theory, the owner can delegate the implementation of policy to any person who is below him/her in organizational hierarchy 56, above him/her in organizational hierarchy 56, or is a peer of him/her in organizational hierarchy 56. In such an embodiment, IDS 30 does not need hierarchy plug-in 46 or organizational hierarchy 56 at all. Rather, delegation engine 48 can simply select an ID that has the minimum required access rights amongst the possible candidate IDs.

Delegation engine 48: As shown in FIG. 2, delegation engine 48 coordinates between the various plug-ins. Specifically, delegation engine 48 communicates with the different plug-ins, and uses the information received from the different plug-ins to decide the implementation ID for the policy. In addition, delegation engine 48 can notify the selected policy implementer ID of the fact that his/her ID will be used for the implementation of the policy. The delegation engine 48 could be programmed to use the ID only if the user approves the use of his/her ID for policy enforcement. If such approval is given, the user credential/ID could be associated with the resource and/or policy and stored in a table 52. For example, revisiting the example given above, in case of the policy defined by the domain expert, if delegation engine 48 determines that a policy for encryption project data should be implemented with the ID who is the owner of the project machine then delegation engine 48 will send a notification to the project machine owner notifying that his/her ID is selected for implementing the policy. The project owner will have to give his/her credentials to delegation engine 48 which can then be stored in table 52, and used for implementing the policy.

Resource Broker 50: In general, resource broker 50 is responsible for monitoring the managed resource and detecting any changes. Changes of interest to resource broker 50 are those changes that might potentially affect the execution of the policy such as, for example: (1) changes to the access control list(s) 54; (2) changes in the structure of the tables used in a policy; (3) changes in the list of users accessing a policy (e.g., this might make some other user ID the best ID to execute a policy); etc. In any event, the detection of changes can be implemented using either a push approach or a pull approach. In the push approach, the resource is an active resource that sends events to resource broker 50. An example of this could be a trigger defined for an ACL table in DB2. In the pull approach, resource broker 50 periodically polls the resource to detect the changes. Once the changes are detected, resource broker 50 notifies delegation engine 48 which finds the set of policies that might be affected. Delegation engine 48 would then trigger the re-evaluation of these policies.

### ILLUSTRATIVE EXAMPLE 1

### Implicit Delegation

The following illustrative example outlines a typical procedure implemented by the present invention in an implicit delegation case. In this case (as with explicit delegation), resource manager 22 is configured with the credentials of the possible implementers. Delegation engine 48 will receive input from policy parser plug-in 42, access plug-in 44 and optionally hierarchy plug-in 46. Assume that LA1 comprises the list of access rights 54 necessary to implement policy 40 as determined by policy parser plug-in 42. Using access plug-in 44, the set or list of users (S1) having the necessary access rights mentioned in LA1 can be identified. From the policy owner and resource indicated in the policy, IDS 30 can create LDAP filter and use hierarchy plug-in 46 (e.g., an LDAP client) to determine who among set of users S1 is permitted to implement (i.e., can be delegated) the policy 40. In this example, such users are referred to as set of users S2, which could be a subset of S1. If the final set S2 contains more than one user, the user with the least access rights (who also meets the minimum access rights determined by policy parser plug-in 42) can be selected. If hierarchy 56 is not used for identifying the implementer, then that step is skipped and the ID from set S1 with the least access rights can be chosen. Regardless, once a user has been selected as implementer (and optionally consented), the owner of policy 40 can be informed, the ID of that user can be associated with the applicable resource and/or policy 40 in table 52, and the user can be automatically identified in policy 40 by delegation engine 48, thereby completing the delegation of implementation thereto.

In description set forth above example, organizational hierarchy 56 can be used to determine a relationship between the policy owner and the policy implementer. In general, such relationship is not limited to manager-subordinate nature. Other types of relationships and their representation based on role hierarchies can also be used.

### ILLUSTRATIVE EXAMPLE 2

### Semi-Implicit Delegation

In semi-implicit delegation, IDS 30 uses the policy parser plug-in to determine the minimum set of access rights required to execute policy 40. Similar to Example 1, IDS 30 may or may not use hierarchy plug-in 46 to identify out the set of users to which the owner can delegate implementation of policy 40. This depends on the configuration used for delegation. In any event, delegation engine 48 will use access plug-in 44 to identify the set of users S1 who have the access rights returned by policy parser plug-in 42, and optionally, also who among set S1 have a desired hierarchical relationship to the owner of policy 40. This information is returned to the owner who will select the most appropriate policy implementer. Once a user has been selected as implementer (and optionally consented), the ID of that user can be associated with the applicable resource and/or policy 40 in table 52, and the user can be manually identified in policy 40 by the owner, thereby completing the delegation of policy implementation thereto. Alternatively, once the owner manually selects the implementer, delegation engine 48 can automatically identify that user in policy 40. The primary difference from the implicit approach is that, in this semi-implicit approach, the pruning step to select one of the many policy implementers is not done by IDS 30.

IV. Computerized Implementation

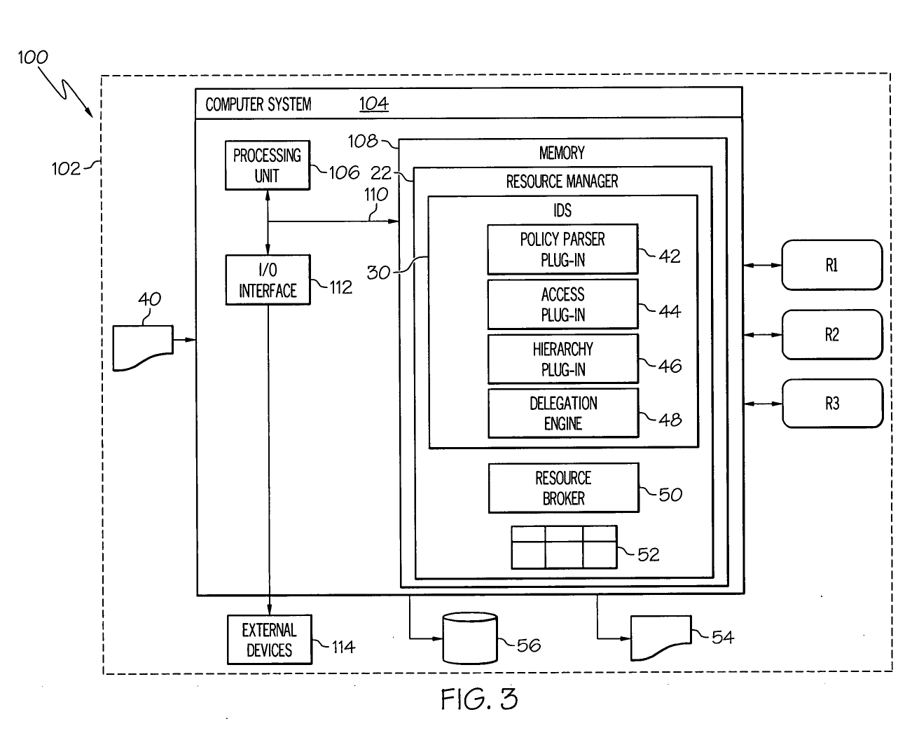

Referring now to FIG. 3, a more specific computerized implementation 100 of the present invention is shown. As shown, FIG. 3 depicts a computer system 104 within infrastructure 102, which is intended to refer to the IT environment/infrastructure of organization 26 shown in FIG. 1. FIG. 3 is intended to represent, among other things, that the present invention could be implemented within a network environment (e.g., the Internet, a wide area network (WAN), a local area network (LAN), a virtual private network (VPN), etc., or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, it should be understood that come or all of the components FIG. 3 could be deployed, managed, serviced, etc. by a service provider who offers handle policy implementation delegation for customers.

In any event, computer system 104 is shown including a processing unit 106, a memory 108, a bus 110, and an input/output (I/O) interfaces 112. Further, computer system 104 is shown in communication with external I/O devices/resources 114. In general, processing unit 106 executes computer program code, such as resource manager 22, which is stored in memory 108. While executing computer program code, processing unit 106 can read and/or write data, to/from memory 108 and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 100 is only illustrative of various types of computer infrastructures for implementing the invention. For example, in one embodiment, computer infrastructure 100 comprises two or more computing devices (e.g., a server cluster) that communicate over a network to perform the various process steps of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 can comprise any combination of various types of data storage and/or transmission media that reside at one or more physical locations. Further, I/O interfaces 112 can comprise any system for exchanging information with one or more external devices 114. Still further, it is understood that one or more additional components (e.g., system software, math co-processing unit, etc.) not shown in FIG. 3 can be included in computer system 104. However, if computer system 104 comprises a handheld device or the like, it is understood that one or more external devices 114 (e.g., a display) could be contained within computer system 104, not externally as shown.

Shown in memory 108 of computer system 104 is resource manager 22, which includes IDS 30, resource broker 50 and table 52. Moreover, as shown, IDS 30 includes policy parser plug-in 42, access plug-in 44, hierarchy plug-in 46 and delegation engine 48. The components perform the functions of the present invention as described above. Specifically, policy parser plug-in 42 will analyze policy 40 to identify a minimum set of access rights needed to delegate implementation of policy 40 for the computerized resource (e.g., R1-R3) specified in/subject to policy 40. Access plug-in 44 will then analyze list 54 to identify a set of users that meet the minimum access requirements. Thereafter, hierarchy plug-in 46 can optionally analyze the organization hierarchy (e.g., in directory 56) to identify who among the set of users is permitted to implement policy 40. As mentioned above, this is based on a hierarchal relationship of the set of users to an owner of policy 40. In any event, based on the input received from access plug-in 44 and any input received from hierarchy plug-in 46, delegation engine 48 can determine who should be delegated implementation of policy 40. Also, delegation engine 48 can automatically identify such user in policy 40 (e.g., in the implicit delegation scenario). Regardless, delegation engine 48 can associate the selected user with the particular resource and/or policy 40 within table 52. As this process is occurring, resource broker 50 can monitor resources R1-R3, list 54, directory 56, etc. for any changes that might affect the process.

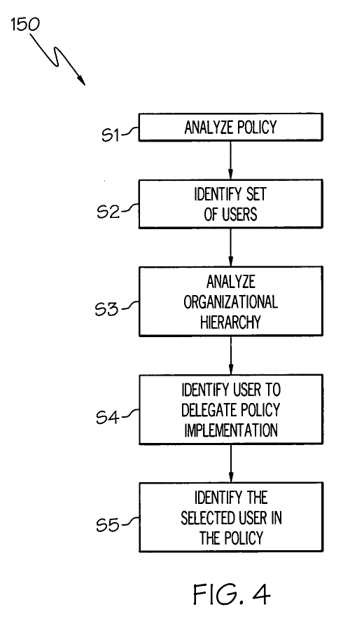

Referring now to FIG. 4, a method flow diagram 150 according to the present invention is shown. As depicted, first step S1 is to parse a policy to determine a minimum set of access rights needed to implement the policy. Second step S2 is to analyze a list to identify a set of users of a computerized resource subject to the policy that meets the minimum set of access rights. Third step S3 is optional and is to analyze a hierarchy to determine who among the set of users is permitted to implement the policy. As indicated above, this step is based on a hierarchical relationship of the set of users to an owner of the policy. Fourth step S4 is to identify/select at least one user from the set of users to implement the policy for the computerized resource. Fifth step S5 is to identify the at least one user in the policy. Based on the particular delegation scenario (e.g., implicit, semi-implicit, explicit), this can be performed automatically or manually.

While shown and described herein as a method and system for policy implementation delegation, it is understood that the invention further provides various alternative embodiments. For example, in one embodiment, the invention provides a computer-readable medium that includes computer program code to enable a computer infrastructure to delegate policy implementation. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 108 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to perform policy implementation delegation. In this case, the service provider can create, maintain, support, etc., a computer infrastructure, such as computer infrastructure 102 (FIG. 3) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for delegating policy implementation. In this case, a computer infrastructure, such as computer infrastructure 102 (FIG. 3), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 104 (FIG. 3), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for delegating policy implementation, comprising:
parsing a policy to determine a minimum set of access rights needed to implement the policy;
analyzing a list to identify a set of users of a computerized resource subject to the policy that meets the minimum set of access rights; and
identifying at least one user from the set of users to implement the policy for the computerized resource.

2. The computer-implemented method of claim 1, further comprising:
analyzing, prior to the identifying step, a hierarchy to determine who among the set of users is permitted to implement the policy based on a hierarchical relationship of the set of users to an owner of the policy.

3. The computer-implemented method of claim 1, wherein the set of users is identified based upon a set of roles and corresponding access rights, as indicated in the list.

4. The computer-implemented method of claim 1, wherein the list associates users of the computerized resource with corresponding access rights.

5. The computer-implemented method of claim 1, further comprising delegating implementation of the policy to the at least one user by identifying the at least one user in the policy.

6. The computer-implemented method of claim 5, wherein the at least one user is identified in the policy automatically.

7. The computer-implemented method of claim 5, wherein the at least one user is identified in the policy manually by an owner of the policy.

8. The computer-implemented method of claim 1, further comprising monitoring the computerized resource for changes.

9. A system for delegating policy implementation, comprising:
a system for parsing a policy to determine a minimum set of access rights needed to implement the policy;
a system for analyzing a list to identify a set of users of a computerized resource subject to the policy that meets the minimum set of access rights; and
a system for identifying at least one user from the set of users to implement the policy for the computerized resource.

10. The system of claim 9, further comprising:
a system for analyzing a hierarchy to determine who among the set of users is permitted to implement the policy based on a hierarchical relationship of the set of users to an owner of the policy.

11. The system of claim 10, wherein the hierarchy contains a hierarchy of users of the computerized resource.

12. The system of claim 9, wherein the list associates users of the computerized resource with corresponding access rights.

13. The system of claim 9, further comprising a system for delegating implementation of the policy to the at least one user.

14. The system of claim 13, wherein the delegating is performed by automatically identifying the at least one user in the policy.

15. The system of claim 13, wherein the delegating is performed by identifying the at least one user to an owner of the policy.

16. The system of claim 9, further comprising a system for monitoring the computerized resource for changes.

17. A program product stored on a computer readable medium for delegating policy implementation, the computer readable medium including program code, which when executed on a computer causes the computer to:
parse a policy to determine a minimum set of access rights needed to implement the policy;
analyze a list to identify a set of users of a computerized resource subject to the policy that meets the minimum set of access rights; and
identify at least one user from the set of users to implement the policy for the computerized resource.

18. The program product of claim 17, wherein the program code further causes to computer system to analyze a hierarchy to determine who among the set of users is permitted to implement the policy based on a hierarchical relationship of the set of users to an owner of the policy.

19. The program product of claim 18, wherein the hierarchy contains a hierarchy of users of the computerized resource.

20. The program product of claim 17, wherein the list associates users of the computerized resource with corresponding access rights.

21. The program product of claim 17, wherein the program code further causes to computer system to delegate implementation of the policy to the at least one user.

22. The program product of claim 21, wherein implementation of the policy is delegated by automatically identifying the at least one user in the policy.

23. The program product of claim 21, herein implementation of the policy is delegated by identifying the at least one user to an owner of the policy.

24. The program product of claim 17, wherein the program code further causes to computer system to monitor the computerized resource for changes.

25. A method for deploying an application for delegating policy implementation:
providing a computer infrastructure being operable to:
parse a policy to determine a minimum set of access rights needed to implement the policy;
analyze a list to identify a set of users of a computerized resource subject to the policy that meets the minimum set of access rights; and
identify at least one user from the set of users to implement the policy for the computerized resource.

26. The method of claim 25, wherein the computer infrastructure is further operable to analyze a hierarchy to determine who among the set of users is permitted to implement the policy based on a hierarchical relationship of the set of users to an owner of the policy.
